(19) United States
(12) Patent Application Publication
(10) Pub. No.: US 2024/0387932 A1
(43) Pub. Date: Nov. 21, 2024

(54) Battery Cell Housing for a Battery Cell of an Electric Storage Device, and Battery Cell

(71) Applicant: Bayerische Motoren Werke Aktiengesellschaft, Muenchen (DE)

(72) Inventors: Julian PATSCHEIDER, Muenchen (DE); Moritz RITTEREISER, Muenchen (DE); Alexander RUPP, Stuttgart (DE); Peter ROESCH, Muenchen (DE); Paul WINKLER, Muenchen (DE)

(21) Appl. No.: 18/578,774

(22) PCT Filed: Jun. 29, 2022
(86) PCT No.: PCT/EP2022/067969

§ 371 Date: Jan. 12, 2024

(30) Foreign Application Priority Data
Jul. 16, 2021 (DE) 10 2021 118 399.5

(51) Int. Cl. H01M 50/291; B60L 50/60; H01M 10/0525; H01M 50/107; H01M 50/152; H01M 50/242; H01M 50/249

(52) U.S. Cl. CPC H01M 50/291; B60L 50/66; H01M 10/0525; H01M 50/107; H01M 50/152; H01M 50/242; H01M 50/249; H01M 2220/20

(57) ABSTRACT

A battery cell housing for a battery cell of an electric storage device of an at least partially electrically operated motor vehicle has at least one interior space which is designed for the arrangement of cell elements of the battery cell. The battery cell housing surrounds the interior space at least partially and has at least one cover element on which an electric terminal of the battery cell is formed. The battery cell housing has at least one profile element which is located on an outer wall of the battery cell housing in such a way that the profile element protrudes beyond the at least one cover element, at least in some regions.

### BACKGROUND AND SUMMARY

The invention relates to a battery cell housing for a battery cell of an electrical storage device of an at least partially electric motor vehicle. The invention also relates to a battery cell.

Electrical energy storage devices comprising a plurality of battery cells are already known from motor vehicle construction. For example, the battery cell may be in the form of a lithium-ion battery cell. In that case, they may be arranged, for example, in a floor region of the motor vehicle. In particular in the event of driving maneuvers and crash situations, a corresponding action of force on the electrical energy store is evident, as a result of which deformation of the battery cells can occur, which in turn can damage the battery cell or, in the extreme case, even have safety-critical effects. It is therefore important to protect the battery cell against corresponding deformation.

DE 10 2008 059 972 A1 relates to a battery, in particular a lithium-ion battery, having a plurality of individual cells connected to one another in series and/or in parallel and a cooling plate arranged on the pole side of the individual cells, wherein the individual cells are arranged in a battery housing with a housing cover in such a way that a free space is formed between a bottom side of the individual cells and a floor of the battery housing. Support elements arranged between and/or under the individual cells project into this free space.

An object of the present disclosure is to provide a battery cell housing for a battery cell and also a battery cell which make it possible to realize safer operation of the battery cell.

This object may be achieved by a battery cell housing and by a battery cell according to the independent patent claims.

Advantageous embodiments are specified in the dependent claims.

One aspect of the disclosure relates to a battery cell housing for a battery cell of an electrical storage device of an at least partially electric motor vehicle, comprising at least one interior space, which is designed for the arrangement of cell elements of the battery cell, wherein the battery cell housing at least partially surrounds the interior space, and comprising at least one cover element, on which an electrical terminal of the battery cell is formed.

It is provided that the battery cell housing has at least one profile element, which is arranged on an outer wall of the battery cell housing in such a way that the profile element at least partially projects beyond the at least one cover element.

The profile element is thus in the form of a support element and may, for example in the event of an action of force on the profile element, transfer the force to the outer wall; consequently, deformation in the interior space and thus of the cell elements, which may be in the form for example of a cathode or anode, can be prevented. Therefore, a reliable force distribution over the outer wall can be realized, as a result of which the battery cell or the cell elements are protected against deformation. This in turn contributes to safety, since for example the risk of a fire owing to the deformation is reduced. The failure sequence is also maintained, if the deformation takes place at all; that means first of all the non-critical profile element is deformed and only then is the protection-worthy cell region deformed.

The profile element can have different topologies. For example, the profile element can taper, have a round, or semicircular, or trapezoidal form, or have other shapes.

The battery cell may for example be in the form of a lithium-ion battery cell. In particular, the battery cell is in the form, for example, of a round cell. In this case, the cover element forms a first terminal, for example a positive terminal of the battery cell. A second cover element, which is formed opposite the first cover element, can then in turn form the opposite terminal, for example the negative terminal. It is self-evident to those skilled in the art that this can also be reversed. Furthermore, it is also self-evident that, for example, the outer wall can form a terminal.

In other words, it is provided in particular that the battery cell housing may be cylindrical, wherein the cover elements each form the terminations of the cylinder. The cell elements, in particular the cathode and the anode, are located in the interior space of the hollow-cylindrical battery cell housing, which is formed in particular by the outer wall. Corresponding dissipating elements can then be used in turn to dissipate the electrical energy from the cell elements. The profile element projects beyond the cover element, with the result that, in particular in the event of a substantially perpendicular action of force on the cover element, the action of force is transferred to the profile element, and the force is thus not applied to the cover element. The profile element may for example also be arranged conjointly on the second cover element. The force thus does not act on the cover element but on the profile element. The profile element in turn makes contact at least with the outer wall and transfers the corresponding force to the outer wall. This makes it possible to prevent deformation of the cell elements in the interior space.

In particular, the profile element is in the form of a cylinder encircling the cover element. The profile element may in particular thus be in the form of an annular cylinder and encircle the cover element around the entire circumference. This makes it possible to improve the take-up of an action of force by the profile element and the transfer of this action of force to the outer wall.

It has also been found to be advantageous if the battery cell housing has a plurality of profile elements, wherein the plurality of profile elements are arranged annularly around the cover element and/or a respective profile element has a form of a crenellation. What is proposed in particular, therefore, is a plurality of profile elements, for example two profile elements, three profile elements, four profile elements, five profile elements, six profile elements, seven profile elements, eight profile elements or more profile elements which encircle the cover element. In particular, the individual profile elements can be spaced from one another. It is therefore advantageous since weight can be saved, since the cutouts are correspondingly not provided with the material. In particular, it is therefore possible to form a crenellated encirclement of the cover element. In particular, it is therefore possible to form a castle-like profile in which the action of force can be reliably discharged to the outer wall.

It is likewise advantageous if the at least one profile element is formed in one piece with the outer wall. In other words, the profile element and the outer wall may be made of the same material. It is also possible to produce the at least one profile element and the outer wall in a single production step. It is therefore easily possible to provide the battery cell housing with reduced outlay.

It is likewise advantageous if the profile element is formed separately from the outer wall and/or an electrically insulating element is formed between the profile element and the outer wall. This allows the profile element to be made of a different material than the outer wall. For example, in that case the profile element can be made of plastic, and the outer wall is made of aluminum, for example. It is thus possible to provide the profile element both with reduced costs and reduced weight. If, for example, the profile element were metallic and made of a different material to the outer wall, it would be advantageous to arrange a corresponding insulating element between the outer wall and the profile element in order to thus prevent a flow of current between the profile element and the outer wall.

In another advantageous embodiment, the battery cell housing has an insulation monitoring device, which is designed to monitor the electrical insulation between the outer wall and the profile element. In particular, for example, a defect in the electrical insulation can thus be detected by the insulation monitoring device and, for example, output to a user of the vehicle, for example a driver of the vehicle, as a warning. For example, the user or driver of the vehicle can be provided with information that there is no longer any electrical insulation between the outer wall and the profile element and it is necessary to exchange the battery cell, for example. In this case, both the electrical insulation on sides of the outer wall and on sides of the profile element can be monitored. In particular, both the profile element and the outer wall can thus be in the form of a sensor element for, for example, monitoring a voltage, wherein in the event of a defect in the electrical insulation this monitoring of the voltage can in turn lead to the ability to identify the defect in the electrical insulation.

It has also been found to be advantageous if the outer wall has a notch around the circumference in the region of the cover element, and the profile element has a substantially L-shaped form and engages in the notch with one arm of the L-shape as support. This makes it possible for the profile element to discharge the action of force reliably to the outer wall. The notch thus serves as support element for the profile element, as a result of which the action of force can be discharged to the outer wall better.

In another advantageous embodiment, the outer wall is substantially hollow-cylindrical. In particular the battery cell, in particular the cell elements, is/are then correspondingly in the form of a round cell or cylindrical cell, respectively. The corresponding cell elements, in particular the cathode and the anode and possible separators, are then in turn arranged in the interior space of the hollow-cylindrical outer wall.

Another aspect of the disclosure relates to a battery cell of an electrical storage device of an at least partially electric motor vehicle, comprising at least one battery housing according to the previous aspect. The disclosure moreover also relates to an electrical storage device comprising a plurality of battery cells. The disclosure moreover also relates to a motor vehicle comprising an electrical storage device. The motor vehicle in this case may be at least partially electric. The motor vehicle may moreover also be fully electric.

In an advantageous embodiment of the battery cell, the battery cell is in the form of a round cell and/or the battery cell comprises a lithium-ion battery cell.

Further features of the technology will emerge from the claims, the figures and the description of the figures. The features and combinations of features mentioned above in the description and the features and combinations of features mentioned below in the description of the figures and/or shown in the figures alone can be used not only in the respectively specified combination, but also in other combinations or individually.

### BRIEF DESCRIPTION OF THE DRAWINGS

The technology will now be explained in more detail on the basis of a preferred exemplary embodiment and with reference to the drawings, in which:

FIG. 1 shows a schematic side view of one embodiment of a motor vehicle comprising one embodiment of an electrical energy store comprising one embodiment of a battery cell;

FIG. 2 shows a schematic sectional view of one embodiment of a battery cell comprising one embodiment of a battery cell housing;

FIG. 3 shows another schematic sectional view of another embodiment of a battery cell comprising another embodiment of a battery cell housing;

FIG. 4 shows yet another schematic sectional view of another embodiment of a battery cell comprising another embodiment of a battery cell housing.

In the figures, elements that are the same or have the same function are provided with the same reference signs.

### DETAILED DESCRIPTION OF THE DRAWINGS

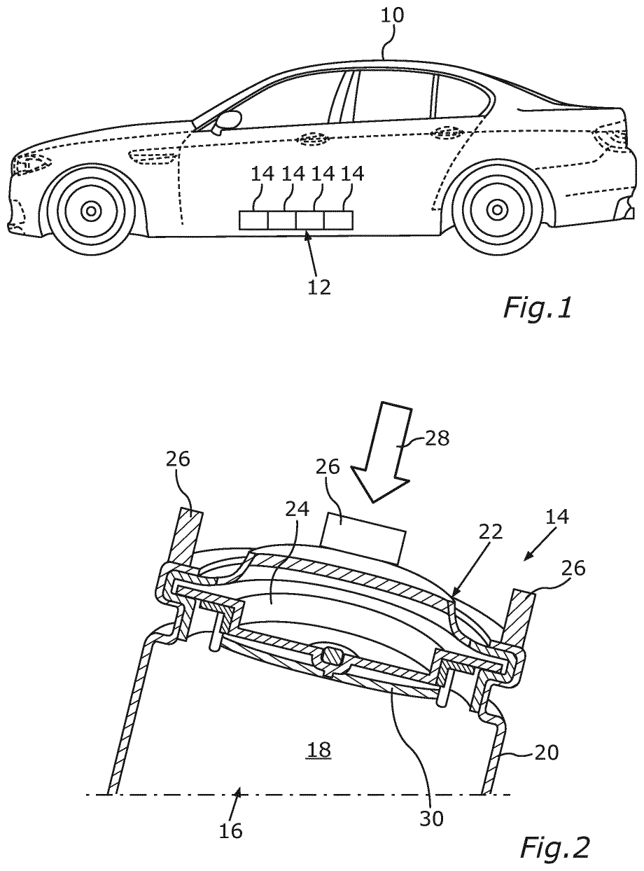

FIG. 1 shows a schematic side view of one embodiment of a motor vehicle 10 comprising one embodiment of an electrical energy store 12. The motor vehicle 10 is at least partially electric. In particular, the motor vehicle 10 may also be fully electric. The electrical energy store 12 may for example serve as a traction battery for an electric drive of the motor vehicle 10. The electrical energy store 12 in the present case comprises a plurality of battery cells 14. The battery cells 14 may be grouped together to form what are referred to as battery modules. The battery cells 14 may also be coupled to one another both in parallel and in series. The battery cells 14 are for example cylindrical, wherein a vertical axis of the cylinder can extend substantially parallel to a vertical axis of the motor vehicle 10.

FIG. 2 shows a schematic sectional view of one embodiment of a battery cell 14. The present case shows in particular one battery cell 14, which may be for example in the form of a round cell and is preferably in the form of a lithium-ion battery cell. The battery cell 14 is designed for the electrical energy store 12. The battery cell 14 has a battery cell housing 16, which in particular has a can-like form. The battery cell housing 16 comprises at least one interior space 18 for arranging cell elements 30, which in the present case are illustrated purely schematically. The cell elements 30 may for example be a cathode or an anode of the battery cell 14. The battery cell housing 16 also has at least one outer wall 20, which partially surrounds the interior space 18. The battery cell housing 16 also has at least one cover element 22, which in turn is in contact with the outer wall 20. The outer wall 20 is in particular provided as a hollow-cylindrical outer wall 20. The cover element 22 terminates the interior space 18 of the hollow cylinder.

A terminal 24 of the battery cell 14, for example, may be formed on the cover element 22. For example, a positive terminal and/or a negative terminal may be formed on the cover element 22.

The battery cell housing 16 has in particular at least one profile element 26, in the present case in particular four profile elements 26, wherein owing to the schematic sectional view only three of them are shown. The profile elements 26 are arranged on the outer wall 20 of the battery cell housing 16 in such a way that the profile elements 26 at least partially project beyond the at least one cover element 22. The present case shows in particular that the battery cell housing 16 comprises the plurality of profile elements 26, wherein the plurality of profile elements 26 are arranged annularly around the cover element 22, and/or the respective profile element 26 has a form of a crenellation.

In the present case, the arrow shows in particular an action of force 28 on the battery cell 14. Owing to the profile elements 26, the action of force 28 now takes place on the profile elements 26, which in turn discharge the action of force 28 to the outer wall 20. The action of force 28 therefore does not take place on the cover element 22, and therefore the corresponding cell elements 30 in the interior space 18 are not deformed, resulting in an increase in safety.

The present exemplary embodiment also in particular shows that the profile elements 26 may be formed in one piece (integrally formed) with the outer wall 20. For example, they may be both metallic and manufactured in particular from the same material as the outer wall 20. The profile elements 26 and the outer wall 20 can also correspondingly be produced in a single manufacturing process.

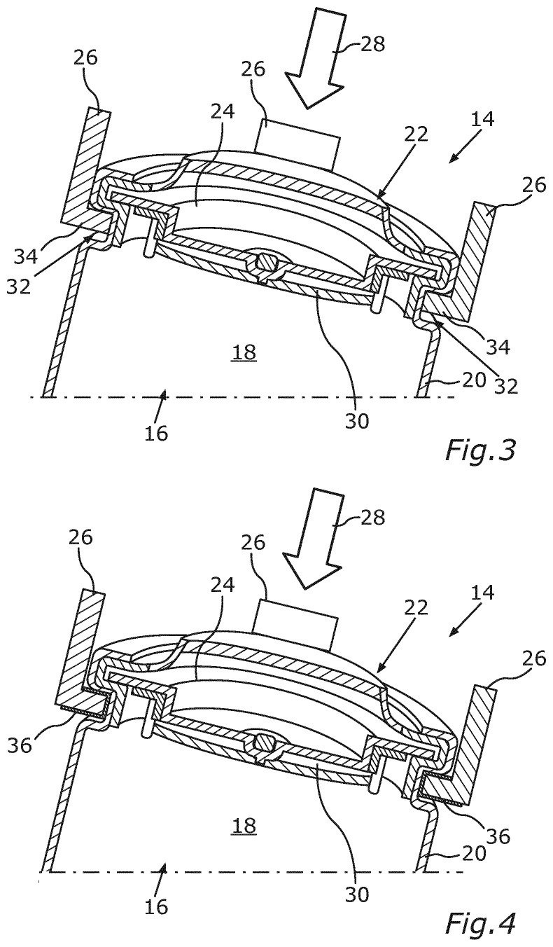

FIG. 3 shows another schematic sectional view of one embodiment of the battery cell housing 16, or the battery cell 14. The present case in particular shows that the profile elements 26 may be formed separately from the outer wall 20, wherein for example the profile elements 26 may be made of plastic in the present case. It is also shown in particular that the outer wall 20 may have a notch 32 around the circumference in the region of the cover element 22 and the profile element 26 may have a substantially L-shaped form and may engage in the notch 32 with one arm 34 of the L shape.

FIG. 4 shows another schematic sectional view of another embodiment of the battery cell 14, or the battery cell housing 16. The present case shows in particular that the profile elements 26 may again be formed separately from the outer wall 20. In the present case, however, they may likewise be metallic. In order then to prevent a flow of current between the outer wall 20 and the profile elements 26, an insulating element 36 in particular may be formed between the profile elements 26 and the outer wall 20. The insulating element 36 may for example be in the form of an insulating layer. In particular, it may then be provided that the battery cell housing 16 additionally has an insulation monitoring device 38, which is designed to monitor the electrical insulation between the outer wall 20 and the profile element 26. For example, in the present exemplary embodiment, the insulation monitoring device 38 can apply a voltage to the profile elements 26. If the profile element 26, for example owing to the action of force 28, were defective, a corresponding change in the voltage could be measured by the insulation monitoring device 38. For example, it is then possible in turn to send a warning message to a superordinate system that corresponding electrical insulation is no longer ensured and, for example, the battery cell 14 must be exchanged.

As an alternative to the embodiments presented in FIG. 2 to FIG. 4, it may also be provided for the profile element 26 to be in the form of a cylinder encircling the cover element 22.

The present case shows in particular that the profile elements 26 or the profile element 26 is formed on only one side of the battery cell 14. It is also possible, of course, to provide that the respective profile elements 26 are formed on either side, in particular on the two cover elements 22, of the battery cell 14.

### LIST OF REFERENCE SIGNS

10 Motor vehicle
12 Electrical energy store
14 Battery cell
16 Battery cell housing
18 Interior space
20 Outer wall
22 Cover element
24 Electric terminal
26 Profile element
28 Action of force
30 Cell elements
32 Notch
34 Arm
36 Electrically insulating element
38 Insulation monitoring device

1-10. (canceled)

11. A battery cell housing for a battery cell of an electrical storage device of an at least partially electric motor vehicle, the battery cell housing comprising:
an interior space designed for arranging cell elements of the battery cell;
an outer wall at least partially surrounding the interior space;
a cover element terminating the interior space, an electrical terminal of the battery cell being disposed on the cover element,
a profile element being arranged on the outer wall of the battery cell housing such that the profile element at least partially projects beyond the cover element.

12. The battery cell housing according to claim 11,
wherein
the profile element has a form of a cylinder encircling the cover element.

13. The battery cell housing according to claim 11,
further comprising a plurality of the profile elements,
wherein
the plurality of the profile elements being arranged annularly around the cover element.

14. The battery cell housing according to claim 11,
further comprising a plurality of the profile elements,
wherein
a respective profile element has a form of a crenellation.

15. The battery cell housing according to claim 11,
wherein
the profile element is integrally formed with the outer wall.

16. The battery cell housing according to claim 11,
wherein
the profile element is formed separately from the outer wall.

17. The battery cell housing according to claim 11,
wherein
an electrically insulating element is disposed between the profile element and the outer wall.

18. The battery cell housing according to claim 11,
wherein
the battery cell housing has an insulation monitoring device designed to monitor electrical insulation between the outer wall and the profile element.

19. The battery cell housing according to claim 11,
wherein
the outer wall has a notch around a circumference thereof in a region of the cover element, and
the profile element has a substantially L-shaped form and engages in the notch with one arm of the L-shaped form as support.

20. The battery cell housing according to claim 11,
wherein
the outer wall is substantially hollow-cylindrical.

21. A battery cell of an electrical storage device of an at least partially electric motor vehicle, the battery cell comprising:
at least one battery cell housing according to claim 11.

22. The battery cell according to claim 21,
wherein
the battery cell is in a form of a round cell.

23. The battery cell according to claim 21,
wherein
the battery cell comprises a lithium-ion battery cell.
